(19) United States
(12) Patent Application Publication
(10) Pub. No.: US 2017/0067192 A1
(43) Pub. Date: Mar. 9, 2017

(54) Flame Resistant Composite Fabrics

(71) Applicant: MMI-IPCO, LLC, Lawrence, MA (US)

(72) Inventors: Moshe Rock, Brookline, MA (US); Shawn Flavin, Sandown, NH (US); David Costello, Marblehead, MA (US); Jane Hunter, Manassas, VA (US); Michael Batson, Windham, NH (US); Gadalia Vainer, Melrose, MA (US); Heidi Carlone, Hooksett, NH (US)

(21) Appl. No.: 15/354,534

(22) Filed: Nov. 17, 2016

Related U.S. Application Data
(62) Division of application No. 14/003,091, filed on Mar. 4, 2014.
Application No. 14/003,091 is a continuation-in-part of application No. 13/045,799, filed on Mar. 11, 2011, now abandoned.
(60) Provisional application No. 61/451,352, filed on Mar. 10, 2011.
(60) Provisional application No. 61/451,352, filed on Mar. 10, 2011.
(60) Provisional application No. 61/326,369, filed on Apr. 21, 2010.

(51) Int. Cl. D04B 1/24; B32B 5/26; B32B 5/02; D02G 3/44; D04B 1/16; D03D 15/12; D03D 1/00; B32B 5/08; C08L 33/20

(52) U.S. Cl. CPC D04B 1/24; B32B 5/08; B32B 5/26; B32B 5/024; C08L 33/20; D04B 1/16; D03D 15/12; D03D 1/0035; D02G 3/443; B32B 2262/0246; B32B 2307/3065; B32B 2437/00; B32B 2317/10; C08L 2201/02; C08L 2201/04; C08L 2205/025; C08L 2205/16; C08L 2205/035; D10B 2321/101; D10B 2331/021

(57) ABSTRACT

A flame resistant composite fabric includes a first flame resistant fabric layer, a second flame resistant fabric layer, and a barrier layer that bonds the first flame resistant fabric layer to the second flame resistant fabric layer. The barrier layer is capable of withstanding temperature of 500° F. for at least 5 minutes without substantial change in the integrity of the flame resistant composite fabric.

This application claims priority from U.S. patent application Ser. No. 13/045,799, filed Mar. 11, 2011, and U.S. Provisional Application No. 61/451,352, filed Mar. 10, 2011, the entire disclosures of which are incorporated herein by reference. U.S. patent application Ser. No. 13/045,799 claims priority from U.S. Provisional Application No. 61/326,369, filed Apr. 21, 2010, the entire disclosure of which is incorporated herein by reference.

### TECHNICAL FIELD

This disclosure relates to flame resistant composite fabrics for use in safety apparel and flame resistant fiber blends for use in flame resistant composite fabrics or garments.

### BACKGROUND

Individuals working in environments where there is a risk of a flash fire need to wear flame resistant protective apparel. Example occupations include, but are not limited to, petrochemical and gas workers, industrial workers, and fire service personnel who seek to wear flame resistant apparel underneath their turnout gear or as a stand-alone garment for use in applications outside structural firefighting.

Individuals working near energized electrical equipment are exposed to potential risk from electric arc flash hazards which can occur from an arc flash event. Electrical arcs are formed in air when potential difference (i.e., voltage) between two electrodes causes atoms in the air to ionize and become able to conduct electricity.

### SUMMARY

In general, this disclosure relates to flame resistant composite fabrics for use in safety apparel.

In one aspect, a flame resistant composite fabric includes a first flame resistant fabric layer, a second flame resistant fabric layer, and a barrier layer that bonds the first flame resistant fabric layer to the second flame resistant fabric layer. The barrier layer is capable of withstanding temperature of 500° F. for at least 5 minutes without substantial change in the integrity of the flame resistant composite fabric.

In another aspect, a flame resistant composite fabric includes a first flame resistant fabric layer, a second flame resistant fabric layer, and a barrier layer that bonds the first flame resistant fabric layer to the second flame resistant fabric layer. The flame resistant composite fabric offers protection from electric arc flash hazards and/or from flash fire hazards in accordance with one or more of the following Nation Fire Protection Association standards: NFPA 70E (2009 ed.), NFPA 1975 (2009 ed.), NFPA 1977 (2005 ed.), NFPA 1951 (2007 ed.), and NFPA 2112 (2007 ed.).

In yet another aspect, a flame resistant composite fabric includes a first flame resistant fabric layer, a second flame resistant fabric layer, and a barrier layer that bonds the first flame resistant fabric layer to the second flame resistant fabric layer. The barrier layer includes an adhesive (e.g., a polyurethane-based adhesive) that includes a flame retardant additive system. The flame retardant additive system includes a brominated aromatic chemical (e.g., decabromodiphenyl oxide (DBDPO), penta bromo phenyl, etc.).

In another aspect, the disclosure describes a fiber blend comprising 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.

In another aspect, the disclosure describes a yarn for use in apparel. The yarn comprises 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.

In another aspect, the disclosure describes a fabric for use in apparel. The fabric comprises a yarn comprising 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.

In another aspect, the disclosure describes a garment comprising a fabric. The fabric comprises 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.

Implementations of the fiber blend, the yarn, the fabric and/or the garment mentioned above and described below may include one or more of the following features. The natural fiber or regenerated fiber is 5 wt % to 10 wt % of the fiber blend, the yarn, the fabric, or the garment. The natural fiber or regenerated fiber is 10 wt % of the fiber blend, the yarn, the fabric, or the garment. The natural fiber or regenerated fiber comprises cotton, wool, rayon, viscose, modal, or lyocell. The fiber blend, the yarn, the fabric, or the garment also comprises 1 wt % to 5 wt % of antistatic fiber. The p-aramid fiber is 7 wt % to 15 wt % of the fiber blend, the yarn, the fabric, or the garment. The p-aramid fiber is 10 wt % of the fiber blend, the yarn, the fabric, or the garment. The m-aramid fiber is 15 wt % to 40 wt % of the fiber blend, the yarn, the fabric, or the garment. The m-aramid fiber is 25 wt % of the fiber blend, the yarn, the fabric, or the garment. The modacrylic fiber is 55 wt % to 65 wt % of the fiber blend, the yarn, the fabric, or the garment. The modacrylic fiber is 60 wt % of the fiber blend, the yarn, the fabric, or the garment. The fiber blend, the yarn, the fabric, or the garment is hydrophilic, e.g. rendered hydrophilic.

Implementations of the fiber blend, the yarn, the fabric and/or the garment may include one or more of the following additional features. The fabric or the garment comprises a knit construction and the yarn is incorporated in the knit construction. The fabric or the garment comprises a woven construction and the yarn is incorporated in the woven construction. The fabric or the garment comprises laminated layers selected from one or more knit constructions including the yarn and one or more woven constructions including the yarn. The fabric or the garment comprises a woven construction laminated with another a woven construction, a woven construction laminated with a knit construction, or a knit construction laminated with another knit construction. The yarn is a stitch yarn and/or a pile yarn. The knit construction comprises circular knit or wrap knit. The circular knit comprises single jersey knit, double knit, terry sinker loop, or cut loop circular knit. The terry sinker loop is in a plaited construction or a reverse plaited construction. The yarn is finished in a single face or a double face. The single face is a plaited single face and the double face comprises a double face velour or pile. The flame resistant composite fabrics or the garment can have a char length according to ASTM D6413 of less than 5 inches. The fabrics or the garment can stop burning, e.g., self-extinguish, within no more than 2 seconds after removal of an external flame source according to ASTM D6413. The average arc resistance rating of the fabrics or the garment according to ASTM F1959 is at least 4 calories per square centimeter per ounce per square yard (“osy” or “ospy”). The heat and thermal shrinkage resistance of the fabrics or the garment tested according to ISO 17493 is less than 10% in both the length and width directions. The fabrics or the garment comply with the requirements of NFPA 2112 for liner fabrics and/or the requirements of NFPA 1977 for thermal liner fabrics.

Implementations of this disclosure may also include one or more of the following additional features. At least one of the first flame resistant fabric layer and the second flame resistant fabric layer is formed of inherent flame resistant fibers, yarns, and/or fabric. At least one of the first flame resistant fabric layer and the second flame resistant fabric layer is formed of flame resistant treated fibers, yarns, and/or fabric. At least one of the first flame resistant fabric layer and the second flame resistant fabric layer is formed of flame resistant (FR) treated cotton, flame resistant treated cotton/nylon fiber blends, meta-aramid, and/or para-aramid fibers, yarns, and/or fabric. At least one of the first flame resistant fabric layer and the second flame resistant fabric layer is formed of modacrylic fibers, yarns, and/or fabric alone, or in a blend with one of more of flame resistant (FR) treated cotton, flame resistant treated cotton/nylon fiber blends, meta-aramid, and/or para-aramid fibers, yarns, and/or fabric. At least one of the first flame resistant fabric layer and the second flame resistant fabric layer is formed of yarns including a flame resistant 88/12 cotton/nylon blend. The flame resistant composite fabric is incorporated in a fabric garment. The barrier layer includes one or more adhesive layers. The one or more adhesive layers may include a chemical additive selected from brominated aromatic chemical (e.g., decabromodiphenyl oxide (DBDPO) and/or penta bromo phenyl, etc.), antimony trioxide, and blends thereof. Alternatively, or in additional, the one or more adhesive layers may include a base polymer (e.g., acrylic, polyurethane, etc.) and a cross-linking agent (e.g., melamine). Alternatively, or in additional, the one or more adhesive layers may include an inherently flame resistant polymer (e.g., polyvinylchloride (PVC)). The barrier layer includes a membrane layer. The barrier layer may also include adhesive layers that bond the membrane layer to the first and second flame resistant fabric layers. The adhesive layers may include a chemical additive selected from brominated aromatic chemical (e.g., decabromodiphenyl oxide (DBDPO), penta bromo phenyl, etc.), antimony trioxide, and blends thereof. Alternatively, or in additional, the adhesive layers may include a base polymer (e.g., acrylic, polyurethane, etc.) and a cross-linking agent (e.g., melamine). Use of a relatively high level of cross-linking agent with a thermoplastic polymer binder/adhesive may cause the thermoplastic polymer binder/adhesive to resemble thermosetting polymer. In some cases, the adhesive layers may include an inherently flame resistant polymer, such as polyvinylchloride (PVC). The flame retardant composite fabric has a controlled air permeability of about 0 ft³/ft²/min to about 200 ft³/ft²/min, tested according to ASTM D-737 under a pressure difference of ½ inch of water across the flame retardant composite fabric. At least one of the first and second flame resistant fabric layers has a raised surface. The first flame resistant fabric layer has an exposed, raised surface. The first flame resistant fabric layer has a weight of about 3 oz/yd² to about 12 oz/yd². The second flame resistant fabric layer has a weight of about 3 oz/yd² to about 12 oz/yd². The barrier layer has a weight of about 2 g/m² to about 12 g/m². The first (inner) flame resistant fabric layer defines one or more raised inner surface regions, facing towards the wearer, e.g., in the form of a pattern selected to generate a channeling effect, the pattern having the form, e.g., of a grid or box. The second (outer) flame resistant fabric layer is an outer woven layer.

Implementations of the disclosure can provide one or more of the following advantages.

The flame resistant composite fabrics of the disclosure offer protection from electric arc and/or flash fire hazards.

The flame resistant composite fabric of the disclosure has a laminated membrane/film/adhesive stabilized by a high level of cross-linking, to reduce thermal shrinking (at 500° F. for 5 minutes).

Alternatively, or in addition, the first and/or second flame resistant fabric layer is a knit or woven fabric where the fiber component(s) will have low shrinkage or no shrinkage when exposed to heat (at 500° F. for 5 minutes). Fibers of a few materials such as m-aramid and p-aramid meet this requirement. It will be preferred to use these fibers, or fiber blends, in the stitch yarns of knit fabrics (which controls the dimensional stability when exposed to high heat) or in woven fabrics (warp and fill).

The raised surface of the knit construction (velour, or grid or box pattern) will be made of the same flame retardant fiber blend as the stitch or other flame retardant yarns, e.g. flame resistant (FR) treated cotton, flame resistant treated cotton/nylon fiber blends, meta-aramid, and/or para-aramid fibers, yarns, and/or fabric; or modacrylic fibers, yarns and/or fabric; or blends of same.

Implementations of the disclosure may also provide one or more of the following advantages. A flame resistant fiber blend is provided for use in flame resistant fabrics or garments. The flame resistant fiber blend contains a mixture of para-aramid (p-aramid) fiber, meta-aramid (m-aramid) fiber, modacrylic fiber, and natural or regenerated fiber. The amount or percentage of each component in the fiber blend is selected to provide the fiber blend with desired properties. For example, the fiber blend has a high limited oxygen index (LOI) and is highly flame retardant. Yarns made from the fiber blend can be used as stitch yarn and/or as loop yarn incorporated in fabrics or garments described in U.S. Pat. No. 6,927,182, the entire disclosure of which is incorporated herein by reference. Fabrics made from the fiber blend can have good integrity when exposed to flame. The fabrics can also endure heavy wearing, e.g., rough abrasion under a military and/or paramilitary body armor, while providing a soft touch to human skin. In addition, the fiber blend can manage water effectively, e.g., by absorbing liquids, such as sweat, from human skin to provide additional comfort or temperature adjustment to the wearer. Selection of the materials also makes the fiber blend cost effective.

It will be preferred not to use thermoplastic fibers, like nylon or flame retardant polyester, in the above fiber blend, or at best to use a very small percentage of such fibers in the fiber blend.

Other aspects, features, and advantages of this disclosure are in the description, drawings, and claims.

### DESCRIPTION OF DRAWINGS

FIG. 1 is a front perspective view of a flame resistant composite fabric garment, in this example, a zippered jacket.

FIG. 2 is an end section view of a flame resistant composite fabric.

FIG. 3 is a side section view illustrating formation of a flame resistant composite fabric of the disclosure.

FIG. 4 is a side section view illustrating formation of another implementation of the flame resistant composite fabric of the disclosure.

FIG. 5A is a side section view illustrating formation of yet another implementation of the flame resistant composite fabric of the disclosure.

FIG. 5B illustrates the effects of controlled stretching on the flame resistant composite fabric of FIG. 5A.

Like reference symbols in the various drawings indicate like elements.

### DETAILED DESCRIPTION

This disclosure relates to flame resistant composite fabrics for use in safety apparel. The composite fabrics include a face fabric (an outer fabric layer) made from a flame resistant (or inherently flame resistant) woven or knit fabric that is permanently bonded with a flame resistant chemistry (e.g., adhesive and additive) to an inner fabric (inner fabric layer) made from a flame resistant woven or knit fabric. The resulting composite meets the flame resistant testing requirements for wearer protection from electric arc flash. Through the selection of materials and processes, the resulting composite can also be adapted to provide a wide range of air permeability.

The disclosure also relates to a flame resistant fiber blend, e.g., for use in flame resistant composite fabrics. The flame resistant fiber blend can include a blend of p-aramid fiber (e.g., Kevlar®), m-aramid fiber (e.g., Nomex®), modacrylic fiber (e.g., Protex®C and/or Protex® M), and one or more natural fibers or regenerated fibers. Optionally, the fiber blend can also include an antistatic fiber. The flame resistant fiber blend can be made into yarns, which in turn can be knitted or woven into flame composite fabrics for use in apparel. For example, the flame resistant composite fabrics are made into safety garments to provide arc protection and flame resistance.

As used herein, “aramid” as used herein refers to a polyamide wherein at least 85% of the amide (—COHN—) linkages are attached directly to two aromatic rings. Suitable aramid fibers are described in Man-Made Fibers—Science and Technology, Volume 2, section titled: “Fiber-Forming Aromatic Polyamides”, page 297, W. Black et al., Interscience Publishers, 1968, the entire disclosure of which is incorporated herein by reference. Aramid fibers are also described in U.S. Pat. Nos. 4,172,938; 3,869,429; 3,819,587; 3,673,143; 3,354,127; and 3,094,511, the entire disclosures of which are also incorporated herein by reference. M-aramids are those aramids having amid linkages in the meta-position relative to each other, and p-aramids are those aramids having the amid linkages in the para-position relative to each other.

As used herein, “flame resistant treated cotton” and “flame resistant (FR) treated cotton blends” such as 88/12 as used herein refer to cotton/nylon or 100% cotton containing fabrics that have been treated with flame resistant chemistry to impart flame retardance. These fabrics have in effect been “treated” to impart FR performance. The two common approaches to treating such fabrics are to bind phosphorus based chemistry to cellulose via use of an ammoniation chamber or via thermal treatment conducted on a thermosol finishing range. As used herein, a “thermosol finishing range” refers to a heated oven that employs dry heat at temperatures ranging from about 175° C. to 230° C. to perform thermosoling. “Thermosoling” as used herein is a process of chemically treating fabrics in which a chemical is diffused and fixed inside the fiber by means of dry heat.

The term “flame resistant fabric,” as used herein, refers to a desired protective layer that has been woven, knitted or otherwise assembled using one or more different types of yarn that are either inherently flame resistant or are treated in fabric form to make them flame resistant. The term “flame resistant composite fabric” as used herein refers to composite fabric created via bonding two or more layers of flame resistant fabrics together without the use of sewing, stitchbonding, quilting, or other processes that utilize a stitch or interlace yarn to combine two or more fabric layers.

In some implementations, the fiber blend includes at least about 5% by weight (“wt %”), e.g., at least about 7 wt %, and/or up to about 25 wt %, e.g., up to about 15 wt %, or 10 wt %, of p-aramid fiber, e.g., Kevlar®. The p-aramid fiber is a high strength material and can provide a yarn made out of the fiber blend with strength, e.g., tensile strength as well as abrasion resistant. In addition, the p-aramid fiber can provide fabric integrity when the fabrics are exposed to flame. For example, the p-aramid fiber restricts (or inhibits) the fiber blend (in the yarn or in the fabrics) from carbonizing and disintegrating and keeps the fabrics integral. Furthermore, the p-aramid fiber can provide toughness to the fabrics for use in heavy wear or rough abrasion, e.g., rough abrasion under military or paramilitary body armor. In some implementations, the flame resistant composite fabrics used at different portions of apparel have different percentages of the p-aramid fiber (or Kevlar®). For example, in a garment to be worn by military or para-military personnel, the garment portions where body armor is located or carried include a higher percentage, e.g., 10 wt % to 15 wt % of the p-aramid fiber, than portions where no body armor is located or carried, which can include, e.g., 8 wt % to 12 wt % of the p-aramid fiber. In some implementations, multiple layers (e.g., knitted layers of the fiber blends) can be used, e.g., laminated, into the fabrics for use in a garment. As an example, the outermost layer can include a high percentage of the p-aramid fiber to protect the garment made from the laminated fabrics from rough abrasion.

In some implementations, the fiber blend includes at least about 10 wt %, e.g., at least about 15 wt %, and/or up to about 40 wt %, e.g., 35 wt %, of m-aramid fiber, e.g., Nomex®. The m-aramid fiber can provide good thermal, chemical, and radiation resistance, and has good flame retardant properties and low thermal shrinkage, e.g., no thermal shrinkage, when exposed to heat (at a temperature of 500° F. for 5 minutes). For example, the m-aramid fiber, e.g., a super flame resistant m-aramid fiber, has a high limiting oxygen index (LOI) of about 37 to about 44. Also, the m-aramid fiber is a strong fiber and can provide the fabric made of the fiber blend with a reasonable abrasion resistance. M-aramid fibers have good strength retention when exposed to heat, as well as good stress-strain property at temperatures above the melting points of other synthetic fibers.

The fiber blend can include at least about 40 wt %, e.g., at least about 55 wt %, and/or up to about 80 wt %, e.g., up to about 65 wt %, or about 60 wt % of modacrylic fiber. The modacrylic fiber is a good flame resistant material, having a high resistance to chemicals and solvents, and a high LOI value of 32-34. In addition, modacrylic fibers are soft and flexible. These fibers can bend easily and have a relatively softer touch to human skin than m-aramid and p-aramid fibers. The modacrylic fiber is also an economical material. Use of the modacrylic fibers in the fiber blend (or the yarn, or the flame resistant composite fiber) can provide the fiber blend with good flame resistant properties at a relatively low cost.

The modacrylic fiber used in the fiber blend can be Protex®C, Protex®M, or a combination of the two materials. Protex®C is finer (having a denier of about 1.7) than Protex®M (having a denier of about 2.2). The selection of Protex®C, Protex®M or their combination can be made based on the desired properties, e.g., being fine, of the yarn to be made from the fiber blend. In some embodiments, the modacrylic fiber used in the fiber blend can include about 10 wt % to about 90 wt % of Protex®C and about 90 wt % to about 10 wt % of Protex®M.

Suitable natural fibers or regenerated fibers for use in the fiber blend can include cotton, wool, rayon, viscose, modal, flame resistant rayon, and others, e.g., lyocell, Tencel® or flame resistant Lenzing®. In some implementations, the fiber blend can include at least about 5 wt % and/or up to about 25 wt %, e.g., up to about 15 wt % or up to about 10 wt %, or about 10 wt %, of natural or regenerated fibers. Inclusion of the natural or regenerated fibers can improve water management capability of the fiber blend without affecting the flame resistant properties of the fiber blend. For example, the fiber blend can remove excessive liquid sweat from human skin, e.g., by wicking the liquid sweat and/or absorbing the liquid sweat from the skin. In some implementations, the natural or regenerated fibers are hydrophilic. The hydrophilicity of the natural fibers can further facilitate the fiber blend to manage water, e.g., sweat from human skin.

Optionally, the fiber blend can include about 1 wt % to about 5 wt % of antistatic fibers to reduce or eliminate static electricity on the surface of the flame resistant composite fabrics. Suitable antistatic fibers can include carbon fiber or synthetic fibers contain carbon or silver.

In some implementations, the fiber blend can include 100% m-aramid, 100% Kevlar®, blend of m-aramid and Kelvar®, or one or more of m-aramid and Kevlar® with additional fibers such as modacrylic, flame resistant cotton, non-flame resistant cotton or cellulosic. Fiber blends having such components (and the yarns or fabric layers containing or made of the fiber blends) can have a low shrinkage, e.g., no shrinkage, when exposed to heat at 500° F. for 5 minutes and a low flammability.

The fiber blend described above can made into yarns using commonly known methods, such as yarn spinning techniques including ring spinning, core spinning, and air jet spinning, or higher air spinning techniques such as Murata air jet spinning. The yarn can be incorporated in a knit, e.g., circular knit or warp knit, or a woven construction. A circular knit construction can include, for example, single jersey or double knit. The yarn can also be incorporated in a plaited construction that includes terry sinker loop finished double face or single face, plain loop, or pillar terry loop. For example, the terry sinker loop is in a plaited construction or a reverse plated construction. In some implementations, the yarn is used in warp knitting, such as double needle bar knitting (Raschel knitting) or tricot (plain or mesh). In additional to being used as a stitch yarn, the yarn can also be used as a pile yarn (e.g., in a fleece, velour, or high pile). The yarn can be used in a raised surface and/or a stitch. The high pile yarn can be made using double needle bar knitting (Raschel knitting) or cut loop circular knit. For example, the loops of the loop circular knit can be cut on a knitting machine or after the knitting as part of the finishing process. Various knit constructions and woven constructions are described in U.S. Pat. No. 6,927,182, the entire disclosure of which is incorporated herein by reference. The yarn can be used in three-end fleeces and in two-end fleeces.

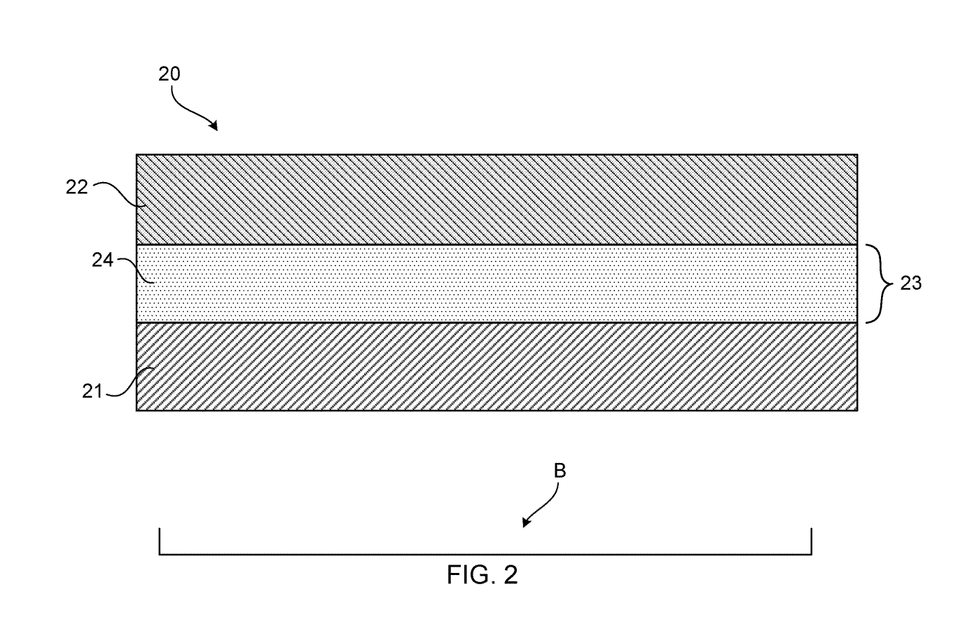

A flame resistant composite fabric made of the yarn can include one or more layers, e.g., laminated layers, of the knit or woven constructions. An example of such a flame resistant composite fabric can be the composite fabric 20 of FIG. 2 discussed below. Each laminated layer, and the composite fabric made of the laminated layers, can have a low thermal shrinkage, e.g., no thermal shrinkage, when exposed to heat at a temperature of 500° F. for 5 minutes. For example, inclusion of the p-aramid or m-aramid in the fiber blend of the laminated layers can reduce the shrinkage of each layer. The laminated layers can include the same or different constructions. In the example of laminating two constructions, a woven construction can be laminated with another woven or a knit construction, or a knit construction can be laminated with another knit construction. In some implementations, a knit construction is tough and can withstand wear well, and a woven construction may be versatile. The lamination of different constructions can provide desired fabric properties. The knit construction in the laminated structure can have a plain surface or a patterned surface including raised portions. In some implementations, the patterned surface provides a desired surface contact with human skin. The various constructions or layers in a laminated structure or fabric can be bonded together, e.g., using an adhesive. In some implementations, the laminated structure or fabric can have a membrane, e.g., a breathable membrane or a water-proof membrane, between the laminated layers or on one or more surfaces of the laminated structure.

In some implementations, the flame resistant fiber blend can be rendered hydrophilic for use, e.g., in fabrics adjacent to human skin. A fiber blend is rendered hydrophilic when the fiber blend is made relatively less hydrophobic, e.g. during processing, as compared to the fiber blend before processing. In some implementations, a yarn made from the fiber blend or a fabric made from the yarn can be processed to be hydrophilic (or relatively less hydrophobic than before being processed). Suitable processing methods can include adding to the fiber blend, the yarn, or the fabric a material such as low molecular weight polyester. For example, the low molecular weight polyester can be added in a dye bath that is used to dye the yarn or the fabric. Suitable low molecular weight polyesters are described, e.g., in U.S. Pat. No. 5,312,667, the entire disclosure of which is incorporated herein by reference.

The fiber blend, yarn, or fabric that is rendered hydrophilic can be used as an inner fabric layer of a garment. As a result, transfer of perspiration from the surface of the inner fabric layer to an outer fabric layer is enhanced because liquid moisture can be transported along the surface fibers of the inner fabric by capillary action. In some implementations, the outer layer of the laminate can be made hydrophobic and/or oleophobic by reducing its surface energy by, for example, depositing particles on the surface of the outer layer to resemble a lotus effect.

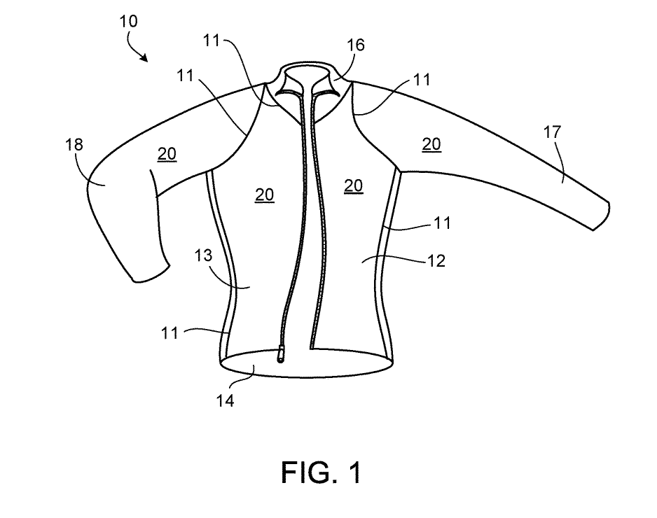

FIG. 1 illustrates a flame resistant composite fabric garment 10 that offers the wearer protection from electric arc and flame hazards. The flame resistant composite fabric garment 10 is formed from a plurality of fabric elements that are joined together by stitching at seams 11. The fabric elements include left and right front elements 12, 13, a rear element 14, a collar element 16, and left and right arm elements 17, 18. Each of these fabric elements is formed of flame resistant (FR) composite fabric.

FIG. 2 illustrates a flame resistant composite fabric 20 suitable for forming the fabric elements. The flame resistant composite fabric 20 consists of a first (inner) fabric layer 21, which forms an inner surface of the fabric garment 10 (FIG. 1) worn towards a user's body, B; and a second (outer) flame resistant fabric layer 22, which forms an outer surface of the fabric garment 10. The first and second fabric layers 21, 22 each can contain or be formed of the fiber blend previously discussed. The first and second flame resistant fabric layers 21, 22 are permanently bonded together via a flame resistant (FR) barrier layer 23 that has a flame resistant chemistry that allows the resulting composite fabric 20 to meet the performance requirements of one or more of the following National Fire Protection Association (NFPA) standards: NFPA 70E HRC2 or HRC3 (2009 ed.), NFPA 1975 (2009 ed.), NFPA 1977 (2005 ed.), NFPA 1951 (2007 ed.), and/or NFPA 2112 (2007 ed.). The entire disclosure of each of the abovementioned National Fire Protection Association (NFPA) standards is incorporated herein by reference.

The flame retardant composite fabric has an air permeability of about 0 ft³/ft²/min to about 200 ft³/ft²/min, tested according to ASTM D-737 under a pressure difference of ½ inch of water across the flame retardant composite fabric. The entire disclosure of ASTM D-737 is incorporated herein by reference. The air permeability of the flame resistant composite fabric can be controlled via the selection of materials used for the first and second flame resistant fabric layers 21, 22, and the flame retardant barrier layer 23.

Referring to FIG. 2, the first flame resistant fabric layer 21 consists of flame resistant fabric. The first (inner) flame resistant fabric layer 21 can, for example, have a construction selected from among, e.g., woven construction having one-way stretch, with or without raised surface; woven construction having two-way stretch, with or without raised surface; knit construction (e.g., circular or warp knit) with or without raised surface (e.g., fleece (lofted) and jersey (flat) knits). The first (inner) flame resistant fabric layer 21 has a weight of about 3 ounces per square yard to about 12 ounces per square yard, and is formed of flame resistant and/or flame resistant treated fibers, yarns, or fabrics selected from flame resistant (FR) treated cotton, FR treated cotton/nylon blends (e.g., 88/12 cotton/nylon), meta-aramid, para-aramid, and/or other inherent FR or FR treated fibers, yarns, and fabrics, e.g., including modacrylic fibers, yarns, and fabrics. In some cases, the first (inner) flame resistant fabric layer 21 can define one or more raised inner surface regions, i.e. facing towards the wearer, in the form of a pattern, such as grid, box, etc., selected to generate a channeling effect, e.g. as described in U.S. Pat. No. 6,927,182, issued Aug. 9, 2005, the entire disclosure of which is incorporated herein by reference.

Referring still to FIG. 2, the second (outer) flame resistant fabric layer 22 consists of a woven or knit (e.g., warp knit or circular knit) flame resistant fabric. Suitable woven fabrics for the second flame resistant fabric layer 22 can be comprised of flame resistant treated cotton fabric or cotton blends such as “88/12” cotton/nylon. Woven fabrics comprised of 100% aramid, aramid blends, and other flame resistant fabrics may also be used. The second flame resistant fabric layer 22 weighs about 3 ounces per square yard to about 12 ounces per square yard, and is formed of flame resistant (FR) treated cotton, FR treated cotton/nylon blends (e.g., 88/12 cotton/nylon), meta-aramid, para-aramid, and/or other inherent FR or FR treated yarns and/or fibers, including, e.g., modacrylic yarns and/or fibers. The second (outer) flame resistant fabric layer 22 may have stretch in at least one direction, e.g., one-way stretch in the width (wale) direction or two-way stretch including stretch in both the width (wale) and the length (course) direction. Alternatively, the second flame resistant fabric layer 22 may be formed from a low stretch or no stretch fabric. The second flame resistant fabric layer 22 can have inherent wind breaking property. The air permeability can be reduced further when the second (outer) flame resistant fabric layer is combined with the barrier layer.

Examples of suitable flame resistant fabrics that can be used as the first (inner) flame retardant fabric layer and/or the second flame retardant (outer) fabric layer are described in U.S. Pat. No. 6,828,003, issued Dec. 7, 2004, the entire disclosure of which is incorporated herein by reference.

As mentioned above, the flame retardant barrier layer 23 is positioned between and permanently bonds the first and second flame resistant fabric layers 21, 22. The flame retardant barrier layer 23 includes an adhesive 24 capable of withstanding exposure to a temperature of 500° F. for 5 minutes without changing the integrity of the composite fabric 20 such as by delamination, separation, shrinking, cracking, etc., as described in the ISO 17493 “Clothing and equipment for protection against heat—Test method for convective heat resistance using a hot air circulating oven” test method requirements, the entire disclosure of which is incorporated herein by reference. Suitable adhesives may include adhesives with low shrinkage at high temperatures, cross-linked adhesives, thermosetting adhesives (1, 2 or 3 component). The adhesive 24 may, in one form, be applied by means of transfer coating from release paper at between 0.25 oz/yd² and 2.5 oz/yd².

The adhesive 24 can be inherently flame resistant, such as a polyvinyl chloride (PVC) based adhesive. Alternatively or additionally, the adhesive 24 can include one or more chemical additives selected from brominated aromatic chemical (e.g., decabromodiphenyl oxide (DBDPO), penta bromo phenyl, etc.), antimony trioxide, and blends thereof, which result in the creation of a flame retardant composite fabric suitable for protection from electric arc and flash fire hazards. In some embodiments, for example, the flame retardant barrier layer 23 includes a polyurethane-based adhesive with an additive system that consists of a blend of DBDPO and antimony trioxide.

Alternatively, or in additional, the adhesive 24 can include a base polymer (e.g., acrylic, polyurethane, etc.) and a cross-linking agent, such as melamine. A relatively high level of cross-linking agent will turn the thermoplastic polymer binder/adhesive to a very stable chemical that may resemble thermosetting polymer.

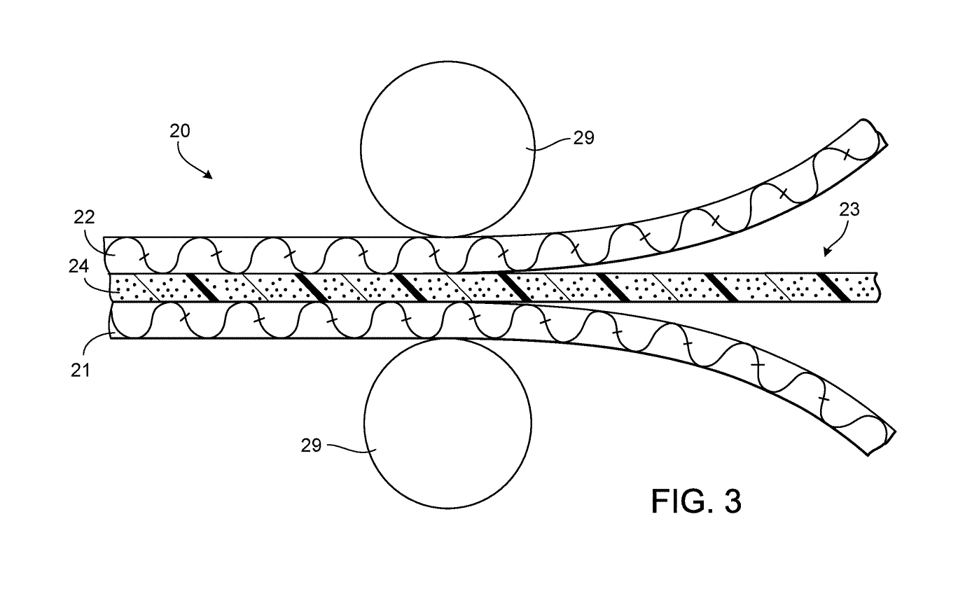

Air permeability can be provided and controlled by applying the adhesive 24 as a continuous layer, and then mechanically modifying the layer of adhesive such as by crushing or stretching. For example, referring to FIG. 3, air permeability can be controlled by applying the adhesive on the fabric and then using some type of mechanical processing, such as treatment with rollers 19, in order to create the desired levels of air permeability.

Still referring to FIG. 3, adhesive 24 may be applied by means of a release paper, wherein the adhesive is first placed on release paper at between about 0.25 oz/yd² and 2.5 oz/yd², after which one of the fabric layers is placed on top of the adhesive in order for bonding to occur between an opposed first surface of the adhesive layer and the fabric layer. The release paper is then stripped from the fabric and the second flame resistant fabric layer is applied to the surface of the adhesive. The composite then undergoes mechanical processing through opposed rollers 29 (which may be heated to a temperature of between about 100° F. and 375° F.), which apply pressure to the composite fabric. As can be appreciated, by changing any mechanical parameter (roller temperature, pressure applied, and speed of the fabric through the rollers), the air permeability characteristics of the composite fabric can also be modified.

Alternatively, and still referring to FIG. 3, adhesive 24 may be applied directly to one of fabric layers 21 and 22 (at 0.25 oz./yd.² to 2.5 oz./yd.²) without the use of release paper. As before, the composite fabric will undergo mechanical processing in order to achieve desired air permeability performance.

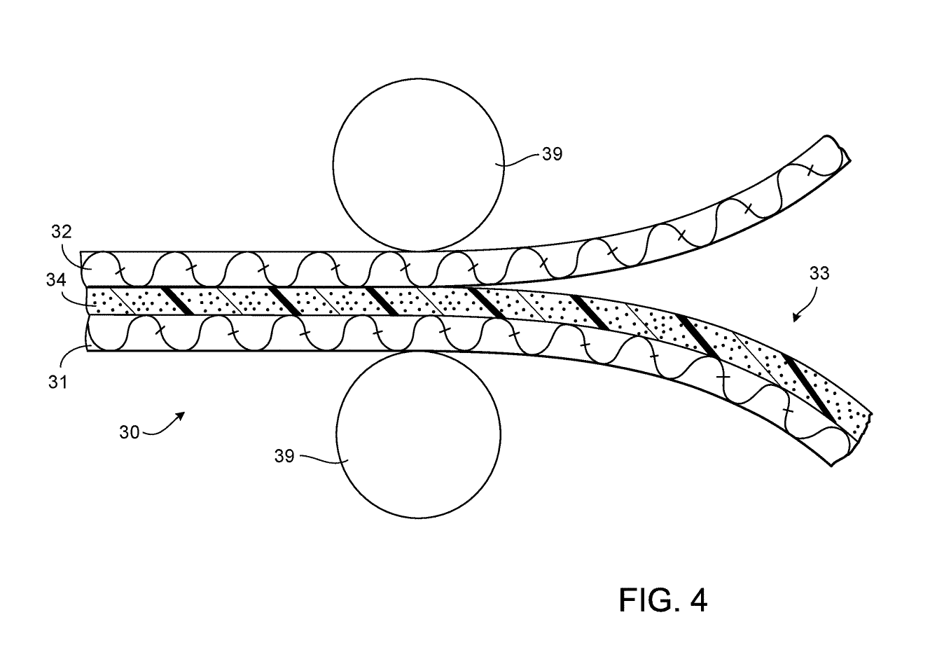

Alternatively, foamed adhesive can be used to provide air permeability. Referring now to FIG. 4, another implementation of the inventive flame retardant composite fabric is shown and generally indicated at 30. The flame retardant composite fabric 30 includes first and second flame resistant fabric layers 31 and 32, and a barrier layer 33 consisting of an intermediate adhesive 34. The barrier layer 33 is capable of withstanding exposure to a temperature of 500° F. for 5 minutes without changing the integrity of the composite fabric 20, such as by delamination, separation, shrinking, cracking, etc. The first and second flame resistant fabric layers 31 and 32 both have flame resistant woven or knit construction, such as described above with reference to FIG. 2.

The adhesive 34 can be inherently flame resistant, such as a polyvinyl chloride (PVC) based adhesive. Alternatively, or in additional, the adhesive 34 can include one or more chemical additives selected from brominated aromatic chemical (e.g., decabromodiphenyl oxide (DBDPO), penta bromo phenyl, etc.), antimony trioxide, and blends thereof, which result in the creation of a flame retardant composite fabric suitable for protection from electric arc and flash fire hazards. In some embodiments, for example, the barrier layer 33 consists of a polyurethane-based adhesive that includes flame retardant additives that consist of a blend of DBDPO and antimony trioxide.

Alternatively, or in additional, the adhesive 34 can include a base polymer (e.g., acrylic, polyurethane, etc.) and a cross-linking agent, such as melamine.

The chemical makeup of the adhesive 34 can help to provide a flame retardant composite fabric that is suitable for protection from electric arc and/or flash fire hazards in accordance with one or more of the following National Fire Protection Association (NFPA) standards: NFPA 70E HRC2 or HRC3 (2009 ed.), NFPA 1975 (2009 ed.), NFPA 1977 (2005 ed.), NFPA 1951 (2007 ed.), and/or NFPA 2112 (2007 ed.). Here, the adhesive 34 is applied as foam at between about 0.3 oz/yd² and 10 oz/yd². The foam density (mixing air with adhesive) and the amount of adhesive applied are selected depending on the desired air permeability of the flame retardant composite fabric 30. The flame retardant composite fabric 30 is prepared by first applying foam adhesive 34 on one of the opposed surfaces of fabric layers 31 and 32. Once the adhesive is applied, the other fabric layer is placed upon the adhesive in order to produce the flame retardant fabric composite of the disclosure. The flame retardant composite fabric 30 is then mechanically processed by means of a pair of rollers 39, which apply pressure thereto in an amount between about 10 lbs./in.² and 150 lbs./in.² in order to produce a composite having a specific level of air permeability.

Air permeability can also be provided by applying the adhesive, e.g., via rotary printing and/or gravure rolling, in a discontinuous pattern, such as in a dot coating pattern.

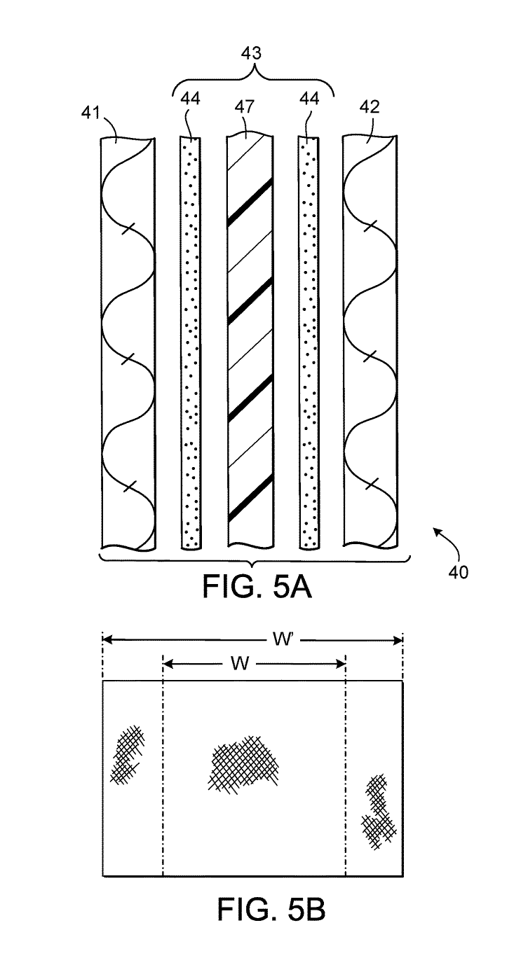

FIG. 5A illustrates yet another implementation of the inventive flame retardant composite fabric of this disclosure, which is generally indicated at 40. The flame retardant composite fabric 40 includes first and second flame resistant fabric layers 41 and 42, both of which have a flame resistant woven or knit construction such as described above with reference to FIG. 2. The flame retardant composite fabric 40 also includes a barrier layer 43 capable of withstanding exposure to a temperature of 500° F. for 5 minutes without changing the integrity of the composite fabric 40 such as by delamination, buckling, etc. The FR barrier layer 43 may consist of a membrane layer 47 disposed between two adhesive layers 44 for adhering the membrane layer 47 between the first and second FR fabric layers 41, 42.

The adhesive layers 44 can be inherently flame resistant, such as a polyvinyl chloride (PVC) based adhesive. Alternatively, or in additional, the adhesive layers 44 can include one or more chemical additives selected from brominated aromatic chemical (e.g., decabromodiphenyl oxide (DBDPO), penta bromo phenyl, etc.), antimony trioxide, and blends thereof, which result in the creation of a flame retardant composite fabric suitable for protection from electric arc and flash fire hazards. In some embodiments, for example, the adhesive layers 44 consist of a polyurethane based adhesive that includes a flame retardant additive system that includes a blend of DBDPO and antimony trioxide.

Alternatively, or in additional, the adhesive layers 44 can include a base polymer (e.g., acrylic, polyurethane, etc.) and a cross-linking agent, such as melamine.

The adhesive layers 44 may be applied by means of transfer coating from release paper at a thickness of between 0.25 oz/yd² and 2.5 oz/yd². The membrane layer 47 can consist of: film, such as full film; breathable membrane; hydrophobic porous membrane; or non-porous hydrophilic membrane with very high water resistance. Examples of suitable membranes are described, e.g., in U.S. patent application Ser. No. 12/368,225, filed Feb. 9, 2009 (U.S. Patent Publication No. 2009-0197491, published Aug. 6, 2009), U.S. patent application Ser. No. 12/494,070, filed Jun. 29, 2009 (U.S. Patent Publication No. 2009-0260126, published Oct. 22, 2009), and U.S. patent application Ser. No. 11/001,893, filed Dec. 1, 2004 (U.S. Patent Publication No. 2005-0097652, published May 12, 2005), the entire disclosure of each of which is incorporated herein by reference. The membrane layer 47 may be applied by means of transfer coating from release paper at a thickness of between 0.0001 in. and 0.010 in., or directly on the fabric surfaces at a thickness of between 0.0003 in. and 0.010 in.

As shown in FIG. 5B, the composite fabric 40 having a width, W, is subjected to controlled stretching to produce a composite having a width, W′, with a desired predetermined level of air permeability.

The membrane layer 47 can also be made of electrospun membrane with good water resistance and controlled air permeability. The air permeability can be controlled via the fineness of the electrospun fibers, which may be about 100 nm to about 1,000 nm in diameter. The electrospun membrane can have a weight of about 2 g/m² to about 15 g/m². Examples of suitable electrospun membranes are described in U.S. patent application Ser. No. 12/354,986, filed Jan. 16, 2009 (U.S. Patent Publication No. 2009-0186548, published Jul. 23, 2009), the entire disclosure of which is incorporated herein by reference.

The various layers can be bonded together as described using one or more of the adhesive application and bonding processes described in U.S. patent application Ser. No. 12/354,986, filed Jan. 16, 2009 (U.S. Patent Publication No. 2009-0186548, published Jul. 23, 2009) and U.S. patent application Ser. No. 12/368,225, filed Feb. 9, 2009 (U.S. Patent Publication No. 2009-0197491, published Aug. 6, 2009), the entire disclosure of each of which is incorporated herein by reference.

### Test Methods

### Abrasion Test

The abrasion performance of fabrics is determined in accordance with ASTM D-3884-01 “Standard Guide for Abrasion Resistance of Textile Fabrics (Rotary Platform, Double Head Method).”

### Arc Resistance Test

The arc resistance of the composite fabrics of the disclosure is determined in accordance with ASTM F-1959-99 “Standard Test Method for Determining the Arc Thermal Performance Value of Materials for Clothing,” the entire disclosure of which is incorporated herein by reference. The flame resistant composite fabrics of the disclosure have an arc resistance of at least 0.8 calories, e.g., at least 1.2 calories per square centimeter per ounce per square yard (“osy” or “ospy”).

### Grab Test

The grab resistance of fabrics is determined in accordance with ASTM D-5034-95 “Standard Test Method for Breaking Strength and Elongation of Fabrics (Grab Test).”

### Limited Oxygen Index Test

The limited oxygen index (LOI) of fabrics is determined in accordance with ASTM G-125-00 “Standard Test Method for Measuring Liquid and Solid Material Fire Limits in Gaseous Oxidants.”

### Tear Test

The tear resistance of fabrics is determined in accordance with ASTM D-5587-03 “Standard Test Method for Tearing of Fabrics by Trapezoid Procedure.” Thermal protection performance test

The thermal protection performance of fabrics is determined in accordance with NFPA 2112 “Standard on Flame Resistant Garments for Protection of Industrial Personnel Against Flash Fire.” The fabrics or garments comply with NFPA 1977 “Standard on Protective Clothing and Equipment for Wildland Fire Fighting.”

### Vertical Flame Test

The char length of the composite fabrics of the disclosure is determined in accordance with ASTM D-6413-99 “Standard Test Method for Flame Resistance of Textiles (Vertical Method),” the entire disclosure of which is incorporated herein by reference.

### LOI

From ASTM G125/D2863. The minimum concentration of oxygen, expressed as a volume percent, in a mixture of oxygen and nitrogen that will just support flaming combustion of a material initially at room temperature under the conditions of ASTM D2863.

### Clothing and Equipment for Protection Against Heat

The convective heat resistance of fabrics or garments is tested using a hot air circulating oven according to the conditions of ISO 17493:2000.

### Thermal Protective Performance (TPP)

The term “thermal protective performance” (or “TPP”) relates to the ability of a fabric to provide continuous and reliable protection to a wearer's skin beneath a fabric when the fabric is exposed to a direct flame or radiant heat.

A 6 inch square fabric specimen is suspended horizontally in a holder over two Meker burners and a radiant panel. Weighted sensors placed on top of the fabric (contact) and 6 mm away (spaced) measure the amount of time required for heat penetrating through the fabric to reach a temperature necessary to cause a 2^{nd}-degree burn. This time is multiplied by the exposure heat flux to yield a TPP rating. The resulting measurement corresponds to the amount of time that passes until the wearer suffers a 2^{nd} degree burn.

### Thermal Shrinkage and Heat Resistance

A 15 inch square specimen that has been washed three times is marked for length and width and suspended in an air-circulating oven at 500° F. for five minutes, and the degree of shrinkage is calculated. For determination of heat resistance, the fabric sample is examined for melting, dripping, separation, or ignition.

### Fabric Features

The flame resistant composite fabrics made of the fiber blend described previously can have good flame resistant properties. For example, the fabrics can have a char length according to ASTM D6413 of less than 5 inches. The char length of the fabrics is measured in a fabric flammability test according to ASTM D6413, in which a fabric sample is suspended vertically above a fixed external flame placed at the lower edge of the fabric sample. The extent of fabric burning (or charring) measured from the edge of the lower fabric sample is the char length of the fabric sample. The fabrics can stop burning, e.g., self-extinguish, within no more than 2 seconds after removal of the external flame source according to ASTM D6413. The average arc resistance rating of the fabrics according to ASTM F1959 is at least 4 calories per square centimeter per ounce per square yard (opsy). The heat and thermal shrinkage resistance of the fabrics tested according to ISO 17493 is less than 10% in both the length and width directions. The fabrics comply with the requirements of NFPA 2112 for liner fabrics and/or the requirements of NFPA 1977 for thermal liner fabrics.

### Instrumented Mannequin

The fabric specimen formed into a size 42 regular coverall garment with specific trim and pocketing configuration is placed on an instrumented mannequin dressed in cotton underwear. The mannequin is subjected to overall heat and flame exposure for three seconds. Sensors embedded in the mannequin predict whether a 2^{nd} or 3^{rd} degree burn will occur at that location and a percent body rating is calculated.

A number of implementations of the disclosure have been described. Nevertheless, it will be understood that various modifications may be made without departing from the spirit and scope of the disclosure. Accordingly, other implementations are within the scope of the following claims.

1-68. (canceled)

69. A fiber blend comprising: 5 wt % to 25 wt % of p-aramid fiber; 10 wt % to 40 wt % of m-aramid fiber; 40 wt % to 80 wt % of modacrylic fiber; and 5 wt % to 15 wt % of natural fiber or regenerated fiber.

70. The fiber blend of claim 69, wherein the natural fiber or regenerated fiber is 5 wt % to 10 wt % of the fiber blend.

71. The fiber blend of claim 70, wherein the natural fiber or regenerated fiber is 10 wt % of the fiber blend.

72. The fiber blend of claim 71, wherein the natural fiber or regenerated fiber comprises cotton, wool, rayon, viscose, modal, or lyocell.

73. The fiber blend of claim 69, further comprising 1 wt % to 5 wt % of antistatic fiber.

74. The fiber blend of claim 69, wherein the p-aramid fiber is 7 wt % to 15 wt % of the fiber blend.

75. The fiber blend of claim 74, wherein the p-aramid fiber is 10 wt % of the fiber blend.

76. The fiber blend of claim 69, wherein the m-aramid fiber is 15 wt % to 40 wt % of the fiber blend.

77. The fiber blend of claim 76, wherein the m-aramid fiber is 25 wt % of the fiber blend.

78. The fiber blend of claim 69, wherein the modacrylic fiber is 55 wt % to 65 wt % of the fiber blend.

79. The fiber blend of claim 78, wherein the modacrylic fiber is 60 wt % of the fiber blend.

80. The fiber blend of claim 69, wherein the fiber blend is hydrophilic.

81. A yarn for use in apparel, the yarn comprising: 5 wt % to 25 wt % of p-aramid fiber; 10 wt % to 40 wt % of m-aramid fiber; 40 wt % to 80 wt % of modacrylic fiber; and 5 wt % to 15 wt % of natural fiber or regenerated fiber.

82. A fabric for use in apparel, the fabric comprising: a yarn comprising 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.

83. The fabric of claim 82, wherein the fabric comprises a knit construction and the yarn is incorporated in the knit construction.

84. The fabric of claim 82, wherein the fabric comprises a woven construction and the yarn is incorporated in the woven construction.

85. The fabric of claim 82, wherein the fabric comprises laminated layers selected from one or more knit constructions including the yarn and one or more woven constructions including the yarn.

86. The fabric of claim 85, wherein the fabric comprises a woven construction laminated with another woven construction, a woven construction laminated with a knit construction, or a knit construction laminated with another knit construction.

87. The fabric of claim 83, wherein the yarn is a stitch yarn and/or a pile yarn.

88. The fabric of claim 83, wherein the knit construction comprises circular knit or wrap knit.

89. The fabric of claim 88, wherein the circular knit comprises single jersey knit, double knit, terry sinker loop, or cut loop circular knit.

90. The fabric of claim 89, wherein the terry sinker loop is in a plated construction or a reverse plated construction.

91. The fabric of claim 82, wherein the yarn is finished in a single face or a double face.

92. The fabric of claim 91, wherein the single face is a plated single face and the double face comprises a double face velour or pile.

93. The fabric of claim 91, wherein the fabric has a char length according to ASTM D6413 of less than 5 inches.

94. The fabric of claim 91, wherein the fabric stops burning within no more than 2 seconds after removal of an external flame source according to ASTM D6413.

95. The fabric of claim 91, wherein the fabric has an average arc resistance rating according to ASTM F1959 of at least 4 calories per square centimeter per opsy.

96. The fabric of claim 91, wherein the fabric has a heat and thermal shrinkage resistance according to ISO 17493 of less than 10% in both the length and width directions.

97. The fabric of claim 91, wherein the fabric complies with the requirements of NFPA 2112 for liner fabrics.

98. The fabric of claim 91, wherein the fabric complies with the requirements of NFPA 1977 for thermal liner fabrics.

99. The fabric of claim 91, wherein the fabric comprises 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.

100. A garment comprising: a fabric comprising 5 wt % to 25 wt % of p-aramid fiber, 10 wt % to 40 wt % of m-aramid fiber, 40 wt % to 80 wt % of modacrylic fiber, and 5 wt % to 15 wt % of natural fiber or regenerated fiber.
